(19) United States
(12) Patent Application Publication
(10) Pub. No.: US 2025/0052958 A1
(43) Pub. Date: Feb. 13, 2025

(54) FIBER OPTIC CABLE ANCHORING DEVICE FOR USE WITH FIBER OPTIC CONNECTORS AND METHODS OF USING THE SAME

(71) Applicants: COMMSCOPE CONNECTIVITY BELGIUM BVBA, KESSEL-LO (BE); COMMSCOPE CZECH REPUBLIC S.R.O., BRNO (CZ)

(72) Inventors: Philippe COENEGRACHT, Hasselt (BE); Jan VOZDECKY, Brno (CZ)

(21) Appl. No.: 18/798,621

(22) Filed: Aug. 8, 2024

Related U.S. Application Data
(63) Continuation of application No. 17/329,890, filed on May 25, 2021, now Pat. No. 12,117,658.
Application No. 17/329,890 is a division of application No. 16/574,596, filed on Sep. 18, 2019, now abandoned.
Application No. 16/574,596 is a continuation of application No. 14/901,226, filed on Dec. 28, 2015, now Pat. No. 10,444,443.
(60) Provisional application No. 61/840,353, filed on Jun. 27, 2013.

(51) Int. Cl. G02B 6/38

(52) U.S. Cl. CPC G02B 6/3889; G02B 6/3821; G02B 6/3849; G02B 6/3871; G02B 6/387

(57) ABSTRACT

A fiber-optic connector housing (50) and cable (20, 20′) are attached together by an anchor (100, 200). The anchor includes a one-piece main body, a passage (110, 210), and an injection port (130, 230). The passage extends between first (102, 202) and second ends (104, 204) of the anchor. Strength members (40, 40′) of the cable are secured within the passage by a bonding material (90) and are thereby anchored to the connector housing. A proximal end (54) of the connector housing includes first (60) and second housing components (70) which capture the anchor. The passage passes through an optical fiber (30) of the cable. The passage includes first (120, 220), second (170, 270), and third portions (180, 280). The first portion radially positions the optical fiber. The second portion receives the bonding material and the strength members. The third portion receives a jacket (26, 26′) of the fiber optic cable. The injection port delivers the bonding material to the passage. The anchor may further include retention tabs (150) that fit within corresponding receivers (62, 72) within the connector.

### CROSS-RFERENCE TO RELATED APPLICATION(S)

This application is a Continuation of U.S. patent application Ser. No. 17/329,890 filed on May 25, 2021, which is a Divisional of U.S. patent application Ser. No. 16/574,596 filed on 18 Sep. 2019, which is a Continuation of U.S. patent application Ser. No. 14/901,226 filed on 28 Dec. 2015, now U.S. Pat. No. 10,444,443, which is a National Stage of PCT/EP2014/063265 filed on 24 Jun. 2014, which claims benefit of U.S. Patent Application Ser. No. 61/840,353 filed on 27 Jun. 2013, the disclosures of which are incorporated herein by reference in their entireties. To the extent appropriate, a claim of priority is made to each of the above disclosed applications.

### TECHNICAL FIELD

The present disclosure relates to fiber optic data transmission, and more particularly to fiber optic cable connection systems.

### BACKGROUND

Fiber optic cables are widely used to transmit light signals for high-speed data transmission. A fiber optic cable typically includes: 1) an optical fiber or optical fibers; 2) a buffer or buffers that surround the fiber or fibers; 3) a strength layer that surrounds the buffer or buffers; and 4) an outer jacket. Optical fibers function to carry optical signals. A typical optical fiber includes an inner core surrounded by a cladding that is covered by a coating. Buffers (e.g., loose or tight buffer tubes) typically function to surround and protect coated optical fibers. Strength layers add mechanical strength to fiber optic cables to protect the internal optical fibers against stresses applied to the cables during installation and thereafter. Example strength layers include aramid yarn, steel, and epoxy reinforced glass roving. Outer jackets provide protection against damage caused by crushing, abrasions, and other physical damage. Outer jackets also provide protection against chemical damage (e.g., ozone, alkali, acids, etc.).

Fiber optic cable connection systems are used to facilitate connecting and disconnecting fiber optic cables in the field without requiring a splice. A typical fiber optic cable connection system for interconnecting two fiber optic cables includes fiber optic connectors mounted at the ends of the fiber optic cables, and a fiber optic adaptor for mechanically and optically coupling the fiber optic connectors together. Fiber optic connectors generally include ferrules that support the ends of the optical fibers of the fiber optic cables. The end faces of the ferrules are typically polished and are often angled. The fiber optic adaptor includes co-axially aligned ports (i.e., receptacles) for receiving the fiber optic connectors that are desired to be interconnected. One example of an existing fiber optic connection system is described at U.S. Pat. Nos. 6,579,014; 6,648,520; and 6,899,467.

Fiber optic connection systems have been developed that are hardened and/or ruggedized. Such hardened fiber optic connectors may provide additional strength and/or weather resistance compared to non-hardened fiber optic connection systems. Strength members within cables of such hardened fiber optic connection systems are typically structurally connected to a hardened fiber optic connector. The hardened fiber optic connector may be further structurally connected to a hardened fiber optic adaptor. The hardened fiber optic adaptor may be structurally connected to an enclosure or other fixedly mounted structure. Loads that are applied to the fiber optic cable are, for the most part, transmitted by the strength members to the fiber optic connector and, in turn, transferred to the fiber optic adaptor and, in turn, transferred to a mounting structure of the hardened fiber optic adaptor. Examples of such hardened fiber optic connection systems are illustrated and described at U.S. Pat. Nos. 7,744,286; 7,744,288; 7,762,726; and 7,942,590, which are all incorporated herein by reference in their entireties.

### SUMMARY OF THE DISCLOSURE

The present disclosure relates to a fiber optic connector and cable assembly including a fiber optic cable, a connector housing, a ferrule, and an anchor. The fiber optic cable includes an optical fiber, a jacket that surrounds the optical fiber, and at least one strength member for providing the fiber optic cable with axial reinforcement. The connector housing includes a first end that is positioned opposite from a second end. The first end defines a plug portion that is adapted for insertion into a fiber optic adaptor, and the second end internally receives at least one strength member and the optical fiber of the fiber optic cable. The ferrule is positioned at the first end of the connector housing. The ferrule receives an end portion of the optical fiber. The ferrule defines an axis that extends through the connector housing from the first end to the second end of the connector housing. The anchor extends between a first end and a second end. The anchor is retained within the connector housing. The second end of the connector housing includes first and second housing components between which the anchor is captured. The anchor includes a passage that extends between the first end and the second end of the anchor. The at least one strength member is secured within the passage of the anchor by a bonding material such that the anchor anchors the at least one strength member to the connector housing.

Other aspects of the present disclosure relate to an anchor for anchoring a fiber optic cable within a fiber optic connector. The anchor includes a main body, a passage, and an injection port. The main body extends between a first end and an opposite second end. The passage extends between the first end and the second end of the anchor. The passage is adapted to pass through an optical fiber of the fiber optic cable. The passage includes a first portion and a second portion. The first portion of the passage is adapted to radially position the optical fiber of the fiber optic cable within the passage. The second portion of the passage is adapted to receive a bonding material and at least one strength member of the fiber optic cable. In certain embodiments, the passage further includes a third portion that is adapted to receive a jacket of the fiber optic cable. The injection port is adapted to deliver the bonding material to the passage of the anchor. In certain embodiments, the anchor further includes at least one retention tab that fits within a corresponding receiver provided within the fiber optic connector.

Still other aspects of the present disclosure relate to a method for anchoring a fiber optic cable within a fiber optic connector. The method includes: 1) providing an anchor that includes a passage; 2) inserting a strength member and an optical fiber of the fiber optic cable within the passage; 3) injecting bonding material within the passage thereby securing the strength member to the anchor; and 4) attaching the anchor within an interior of the fiber optic connector.

A variety of additional inventive aspects will be set forth in the description that follows. The inventive aspects can relate to individual features and to combinations of features. It is to be understood that both the foregoing general description and the following detailed description are exemplary and explanatory only and are not restrictive of the broad inventive concepts upon which the embodiments disclosed herein are based.

### BRIEF DESCRIPTION OF THE DRAWINGS

FIG. 1 is a perspective view of an example fiber optic connection system according to the principles of the present disclosure;

FIG. 2 is the perspective view of FIG. 1, but with a cutaway taken through a vertical center plane;

FIG. 3 is an exploded perspective view of the fiber optic connection system of FIG. 1;

FIG. 4 is the exploded perspective view of FIG. 3, but with a cutaway taken through the vertical center plane;

FIG. 5 is a perspective view of a connector housing and an anchor of the fiber optic connection system of FIG. 1 according to the principles of the present disclosure;

FIG. 6 is the perspective view of FIG. 5, but with a cutaway taken through the vertical center plane;

FIG. 7 is a perspective view of a first housing component of the connector housing of FIG. 5;

FIG. 8 is the perspective view of FIG. 7, but with a cutaway taken through the vertical center plane;

FIG. 9 is a perspective view of a second housing component of the connector housing of FIG. 5;

FIG. 10 is a perspective view of the anchor of FIG. 5;

FIG. 11 is the perspective view of FIG. 9, but with a cutaway taken through the vertical center plane;

FIG. 12 is the perspective view of FIG. 10, but with a cutaway taken

through the vertical center plane;

FIG. 13 is a side elevation view of the anchor of FIG. 5;

FIG. 14 is a distal end elevation view of the anchor of FIG. 5;

FIG. 15 is a proximal end elevation view of the anchor of FIG. 5;

FIG. 16 is a bottom plan view of the anchor of FIG. 5;

FIG. 17 is a cross-sectional view of the anchor of claim 5, as called out at FIG. 16;

FIG. 18 is an exploded perspective view of another fiber optic connection system according to the principles of the present disclosure;

FIG. 19 is another exploded perspective view of the fiber optic connection system of FIG. 18;

FIG. 20 is a perspective view of an anchor of the fiber optic connection system of FIG. 18 attached to a fiber optic cable;

FIG. 21 is another perspective view of the anchor of FIG. 20 attached to the fiber optic cable;

FIG. 22 is a side elevation view of the anchor of FIG. 20 attached to the fiber optic cable;

FIG. 23 is a bottom plan view of the anchor of FIG. 20 attached to the fiber optic cable;

FIG. 24 is a cross-sectional top view of the anchor of cable 20 attached to the fiber optic cable, as called out at FIG. 22;

FIG. 25 is a cross-sectional side elevation view of the anchor of FIG. 20, as called out at FIG. 23;

FIGS. 26A through 26F are a series of six perspective views that illustrate an example method of applying the fiber optic connection system of FIG. 18, including the anchor of FIG. 20, to the fiber optic cable of FIG. 20;

FIG. 26A is a perspective view of the fiber optic cable of FIG. 20;

FIG. 26B is a perspective view of the fiber optic cable of FIG. 20 with the anchor of FIG. 20 attached thereto;

FIG. 26C is a cutaway perspective view of the fiber optic cable of FIG. 20 with the anchor of FIG. 20 attached thereto;

FIG. 26D is a perspective view of the fiber optic cable of FIG. 20 with the anchor of FIG. 20 attached thereto and a ferrule attached to an optical fiber of the fiber optic cable;

FIG. 26E is a perspective view of the fiber optic cable of FIG. 20 with the anchor of FIG. 20 and the ferrule of FIG. 26D attached thereto and with a first housing component and a second housing component installed over the anchor; and

FIG. 26F is a cutaway perspective view of the fiber optic cable of FIG. 20 with the anchor of FIG. 20 and the ferrule of FIG. 26D attached thereto and with the first and second housing components of FIG. 26E installed over the anchor.

### DETAILED DESCRIPTION

According to the principles of the present disclosure, a fiber optic cable can be securely attached to a fiber optic connector. In certain embodiments, crimp bands, crimp rings, etc. are not used. Instead, strength members of a fiber optic cable are internally bonded within an anchor that anchors the strength members to a fiber optic connector. In certain embodiments, a passage extends through the anchor, and the strength members are inserted within the passage and bonded within the passage to the anchor. An optical fiber of the fiber optic cable may also extend through the passage of the anchor. In certain embodiments, the strength members terminate within the passage of the anchor. The fiber optic cable may thereby be terminated by the fiber optic connector. In certain embodiments, the fiber optic connector may be a hardened fiber optic connector.

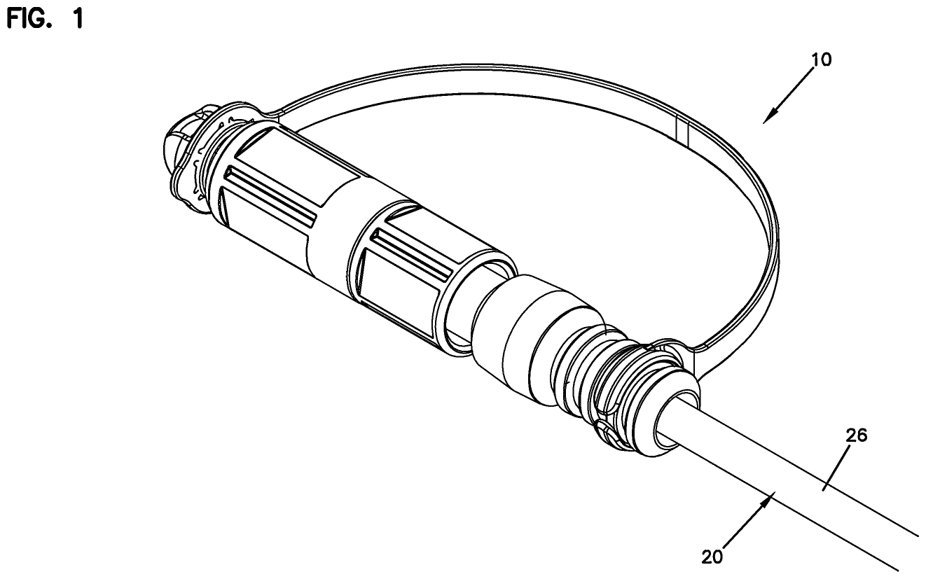

Turning now to FIGS. 1-4, an example fiber optic connector and cable assembly 10 is illustrated. The fiber optic connector and cable assembly 10 includes a fiber optic cable 20, a connector housing 50, and an anchor 100. In the illustrated embodiment, the fiber optic cable 20 is a cylindrical fiber optic cable. The fiber optic cable 20 includes a jacket 26, surrounding a layer of strength members 40 and an optical fiber 30 that is surrounded by the strength members 40 and the jacket 26. The connector housing 50 extends between a first end 52 and a second end 54. A plug portion 56 is positioned adjacent the first end 52. In the depicted embodiment, the connector housing 50 includes a first housing component 60 and a second housing component 70. In the depicted embodiment, the first housing component 60 is a one-piece main body that includes the plug portion 56 and a proximal extension 64 that extends proximally from the plug portion 56. In the depicted embodiment, the second housing component 70 is a cover that covers the proximal extension 64 and thereby forms a passage 58 between the second housing component 70 and the proximal extension 64. The passage 58 continues from the first end 52 to the second end 54 of the connector housing 50. A ferrule 80 may be positioned at the first end 52 of the connector housing at least partially within the passage 58. An end portion 22 of the fiber optic cable may be inserted through the second end 54 of the connector housing 50 and through the passage 58. The end portion 22 of the fiber optic cable 20 may be prepared prior to the insertion into the passage 58 of the connector housing 50. For example, an end portion of the jacket 26 may be stripped away thereby exposing an end portion 32 of the optical fiber 30. In addition, the strength members 40 may be trimmed back. In the depicted embodiment, the strength members 40 extend beyond the trimmed end of the jacket 26 after trimming. The anchor 100 may be pre-applied to the fiber optic cable 20 prior to the insertion of the end portion 22 into the passage 58. Additional details of the anchor 100 and its attachment to the fiber optic cable 20 are provided hereafter.

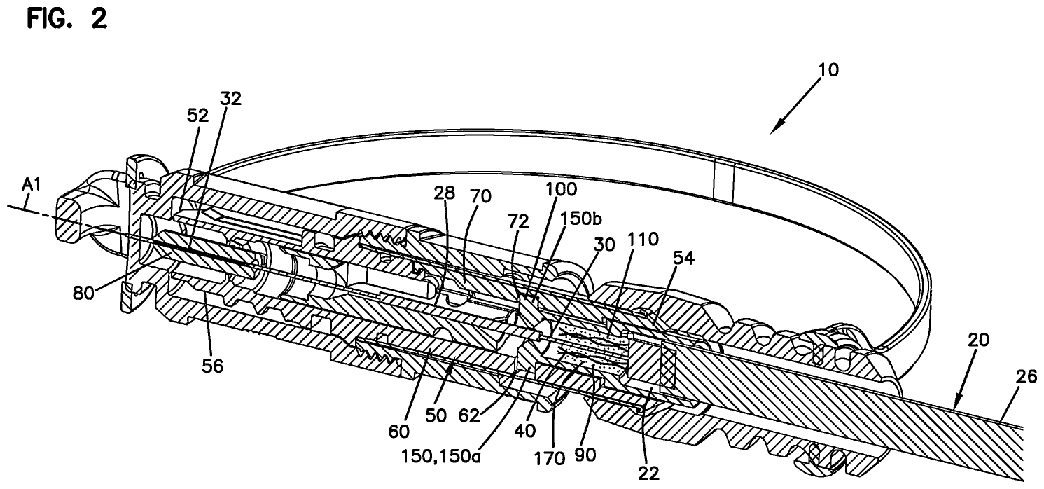

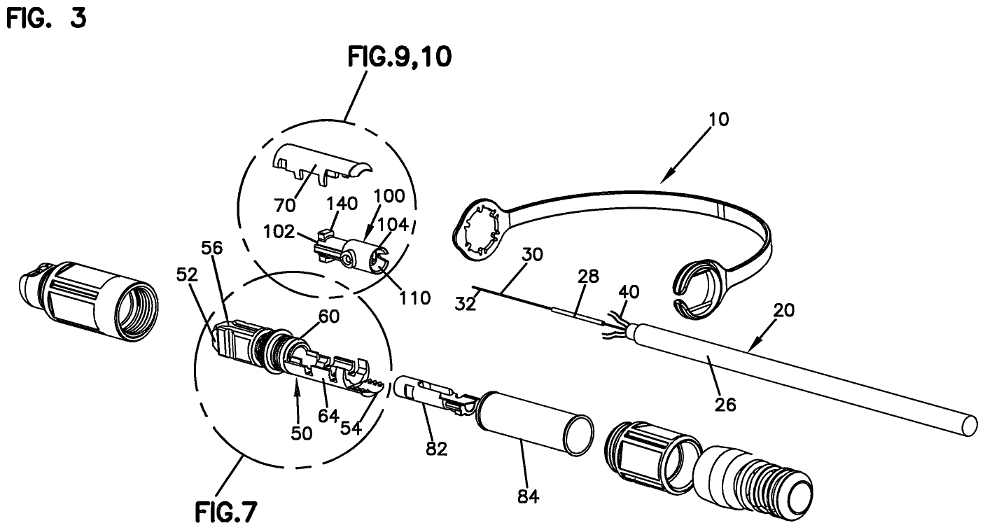

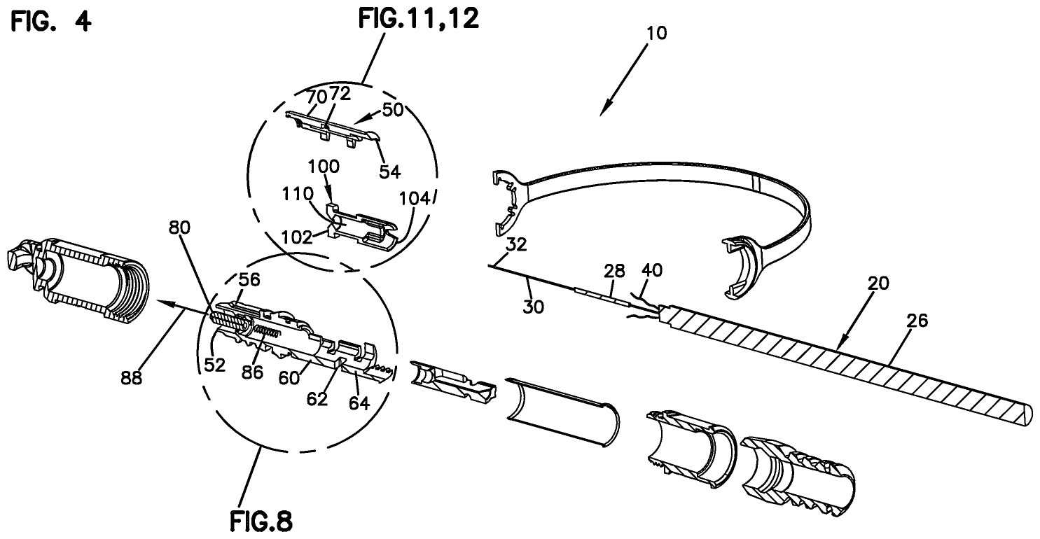

As illustrated at FIG. 4, a spring 86 may be included within the passage 58. The spring 86 may urge the ferrule 80 in a direction 88 that extends from the second end 54 toward the first end 52 of the connector housing 50 along an axis A1 (see also FIG. 2). The spring 86 may be retained by a spring holder 82 (see FIG. 3).

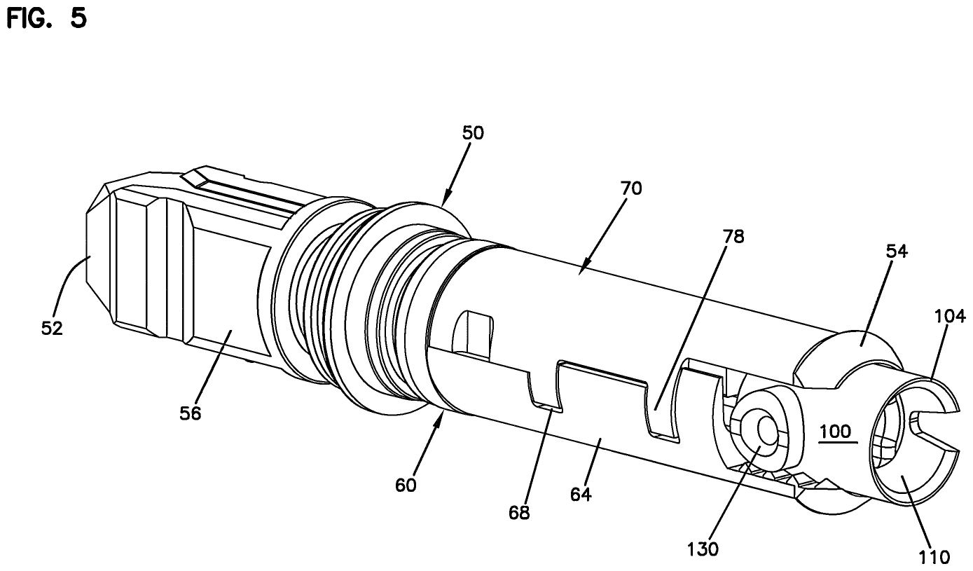

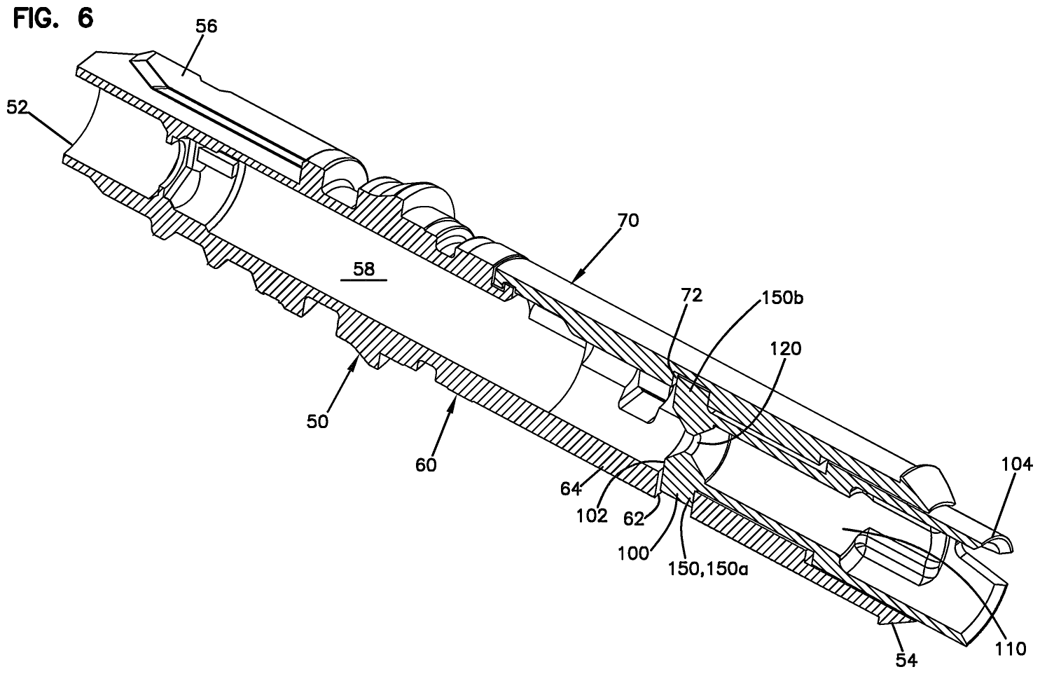

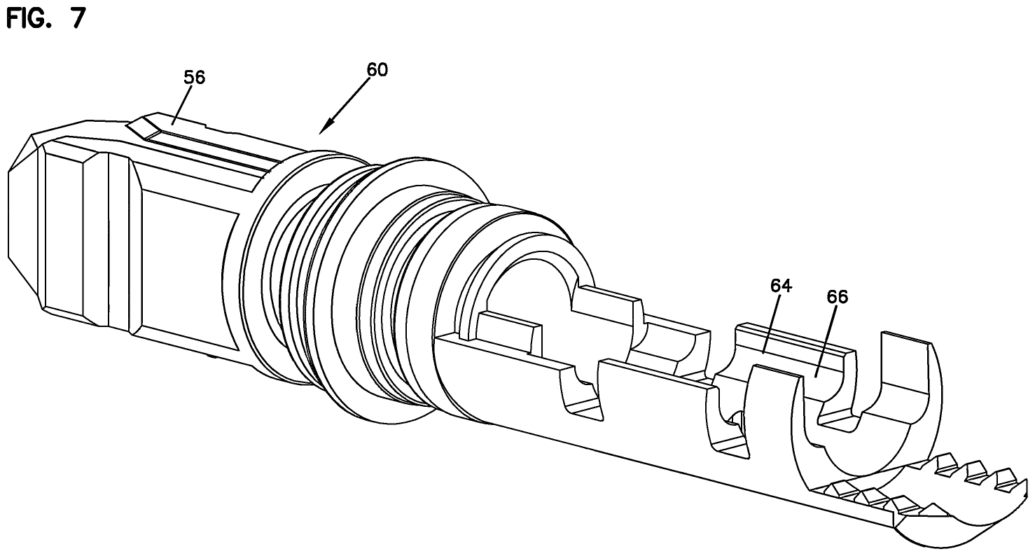

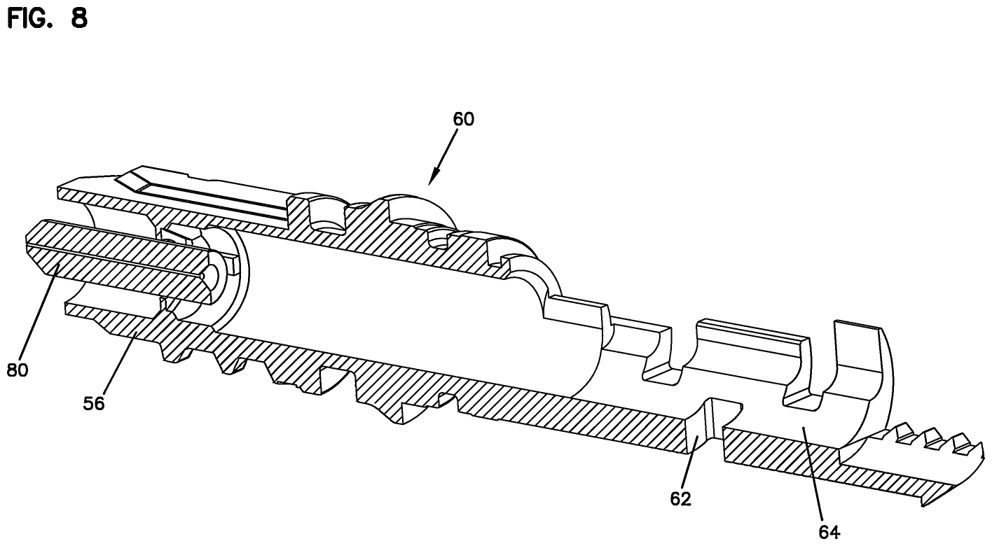

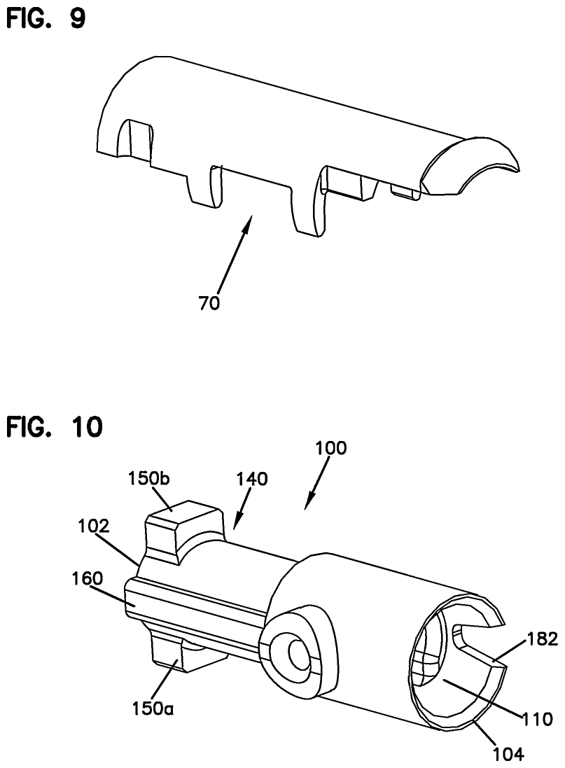

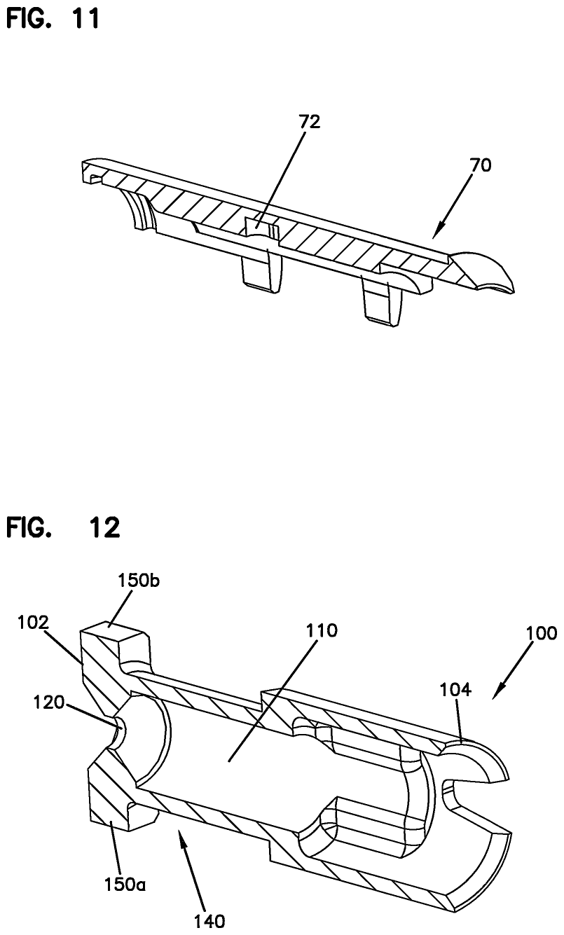

Turning now to FIGS. 5-12, the connection between the anchor 100 and the connector housing 50 will be described in detail. The anchor 100 includes an attachment portion 140. In the depicted embodiment, the attachment portion 140 includes a pair of retention tabs 150. In particular, the pair of retention tabs 150 includes a first retention tab 150a and a second retention tab 150b. As illustrated at FIG. 6, the first retention tab 150a is received within a receiver 62 of the first housing component 60. Similarly, the second retention tab 150b is received within a receiver 72 of the second housing component 70. As can be seen at FIG. 4, engaging the first retention tab 150a into the receiver 62 can be accomplished by vertically dropping the anchor 100 into the uncovered proximal extension 64 of the first housing component 60. If the fiber optic cable 20 is pre-installed in the anchor 100, the end portion 32 may be threaded through the passage 58 that extends through the plug portion 56 prior to the final dropping of the anchor 100 into the open proximal extension 64. Upon the positioning of the anchor 100 into a portion of the passage 58 that extends through the proximal extension 64, the second housing component 70 is dropped over the anchor 100. In particular, the receiver 72 of the second housing component 70 is dropped over the second retention tab 150b. In addition to the retention tabs 150 and the receivers 62, 72, the anchor 100 may include a set of protrusions 160 (see FIG. 10). The protrusions 160 may seat within grooves 66 of the first housing component 60 (see FIG. 7).

In the depicted embodiment, the housing components 60, 70 include the female half of the connection and the anchor 100 includes the male half of the connection. In other embodiments, the receivers 62, 72 may be replaced with a male member, such as a tab. Likewise, the retention tabs 150 of the anchor 100 may be replaced with a female member, such as a receiver. In the depicted embodiment, the anchor 100 extends between a first end 102 and a second end 104. In the depicted embodiment, the retention tabs 150 are adjacent the first end 102 of the anchor 100. In the depicted embodiment, the second end 104 of the anchor extends proximally beyond the second end 54 of the connector housing 50.

In the depicted embodiment, the first housing component 60 and the second housing component 70 interlock with each other. For example, the first housing component 60 includes a plurality of notches 68 (see FIG. 5), and the second housing component 70 includes a plurality of tabs 78. The plurality of tabs 78 engage the plurality of notches 68 and thereby interconnect the second housing component 70 to the first housing component 60. Upon engagement of the first and second housing components 60, 70, a tube 84 may be positioned over the second housing component 70 and the proximal extension 64 of the first housing component 60 thereby securing the connector housing assembly 50.

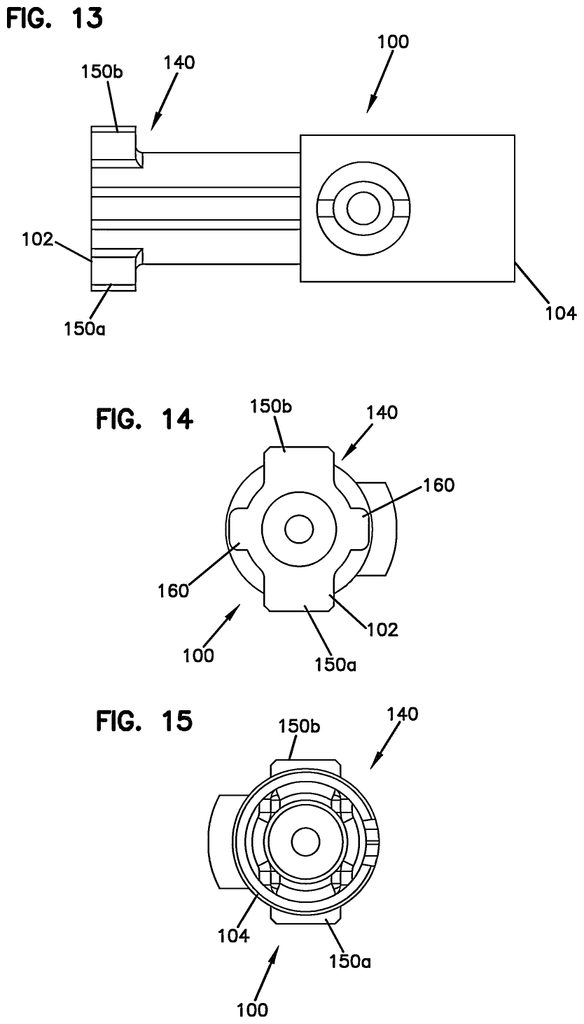

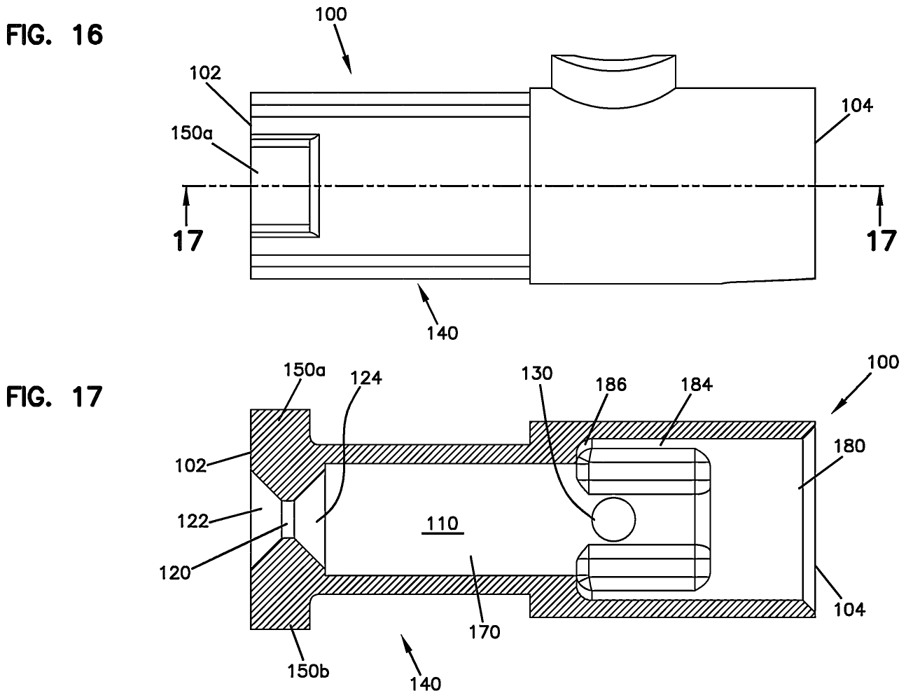

Turning now to FIGS. 13-17, the anchor 100 will be described in detail. The anchor 100 includes a passage 110 that extends through the anchor 100 from the first end 102 to the second end 104. When assembled, the passage 110 is adapted to receive the optical fiber 30. In particular, the optical fiber 30 extends through the passage 110 and through the first end 102 and the second end 104 of the anchor 100. The passage 110 is further adapted to receive the strength members 40 within the passage 110. As depicted, the strength members 40 terminate within the passage 110. The passage 110 of the anchor 100 is further adapted to receive bonding material 90 (see FIG. 2). The bonding material 90 holds the strength members 40 to the anchor 100. In certain embodiments, the bonding material 90 may be an epoxy.

In certain embodiments, the bonding material 90 may adhere to the optical fiber 30 and thereby secure the optical fiber 30 within the passage 110 of the anchor 100. In other embodiments, a tube 28 (see FIG. 3) may be positioned over the optical fiber 30. In such embodiments, the tube 28 may prevent the bonding material 90 from adhering to the optical fiber 30.

The anchor 100 may include an injection port 130. The injection port 130 is adapted to inject the bonding material 90 into the passage 110 after the strength members 40, the optical fiber 30, and, optionally, the tube 28 have been installed in the passage 110. As depicted at FIG. 5, the injection port 130 may be accessible after the anchor 100 has been installed within the connector housing 50. As illustrated at FIG. 5, the injection port 130 may be positioned such that excess portions of the bonding material 90 at or around the outside of the injection port 130 do not interfere with the fitment of the first housing component 60 and the second housing component 70.

Turning now to FIG. 17, the passage 110 of the anchor 100 will be described in detail. The passage 110 includes a necked-down portion 120. In the depicted embodiment, the necked-down portion 120 is adjacent the first end 102 of the anchor 100. The necked-down portion 120 may be adapted to center and/or otherwise guide the optical fiber 30 within the passage 110 and/or guide the optical fiber 30 adjacent the first end 102 of the anchor 100. The necked-down portion 120 may also be adapted to guide the tube 28 and thereby center and/or position the tube 28 within the passage 110 and/or adjacent the first end 102 of the anchor 100. The necked-down portion 120 may further serve as a control to eliminate or reduce or restrict the bonding material 90 from flowing beyond the first end 102 of the anchor 100. As depicted, the necked-down portion 120 includes an outer taper 122 and an inner taper 124. The tapers 122 and/or 124 may act as guides for the optical fiber 30 and/or the tube 28 and thereby case installation of the end portion 32 of the optical fiber 30 when inserting the end portion 32 through the passage 110 of the anchor 100. The taper 122 may collect the bonding material 90. For example, if a drip of the bonding material 90 leaks past a narrowest portion of the necked-down portion 120, the taper 122 may collect the drip of the bonding material 90.

The passage 110 may further include a main portion 170. As depicted at FIG. 2, the strength members 40 are encased by the bonding material 90 within the main portion 170 of the passage 110. In the depicted embodiment, the main portion 170 is relatively large in size. In other embodiments, the main portion 170 is reduced in size. In still other embodiments, the bonding material 90 adheres to the strength members 40 at a bonding portion that may be within the main portion 170.

The passage 110 of the anchor 100 further includes a cable jacket portion 180, in certain embodiments. The cable jacket portion 180 is adapted to receive the jacket 26 of the fiber optic cable 20. In particular, the jacket 26 may include an exterior shape that substantially matches an interior shape of the cable jacket portion 180.

In certain embodiments, the cable jacket portion 180 may include a notch 182 (see FIG. 10). In certain embodiments, the notch 182 may allow excess material from the jacket 26 of the fiber optic cable 20 to accumulate within the notch 182. The jacket 26, even if slightly oversized, may thereby be inserted within the cable jacket portion 180 of the passage 110. In certain embodiments, the notch 182 allows the cable jacket portion 180 to expand slightly in diameter and thereby accommodate the jacket 26 of the fiber optic cable 20, even if slightly oversized.

In certain embodiments, the notch 182 may be used as a tool to collect portions of the strength members 40 that are outside of the passage 110. In particular, if the jacket 26 and/or the fiber optic cable 20 is partially inserted or fully inserted into the passage 110, the portions of the strength members 40 that are outside of the passage 110 may be collected by the notch 182 by rotating the anchor 100 relative to the fiber optic cable 20 about the axis A1. As the portions of the strength members 40 that are outside of the passage 110 pass by the notch 182, the notch 182 traps the portions and funnels them into the passage 110. The relative rotating motion about the axis A1 may be combined with a relative translating motion between the anchor 100 and the fiber optic cable 20.

The cable jacket portion 180 may further include an annular portion 184 and/or portions of an annular portion 184 (see FIG. 17). The annular portion 184 may be used to receive both an outer surface of the jacket 26 and an interior surface of the jacket 26. The cable jacket portion 180 may further include a bottom 186. The distal end of the cable jacket 26 may bottom out upon insertion of the jacket 26 within the cable jacket portion 180 of the passage 110.

The fit of the cable jacket portion 180 over the cable jacket 26 may substantially prevent the bonding material 90 from leaking beyond the second end 104 of the anchor 100. The fit of the necked-down portion 120 and/or the cable jacket portion 180 with the fiber optic cable 20, the optical fiber 30, and/or the tube 28 may allow air to vent as the bonding material 90 is injected through the injection port 130. A suitable viscosity for the bonding material 90 may be selected to eliminate and/or minimize bonding material 90 from leaking beyond the necked-down portion 120 and/or the cable jacket portion 180.

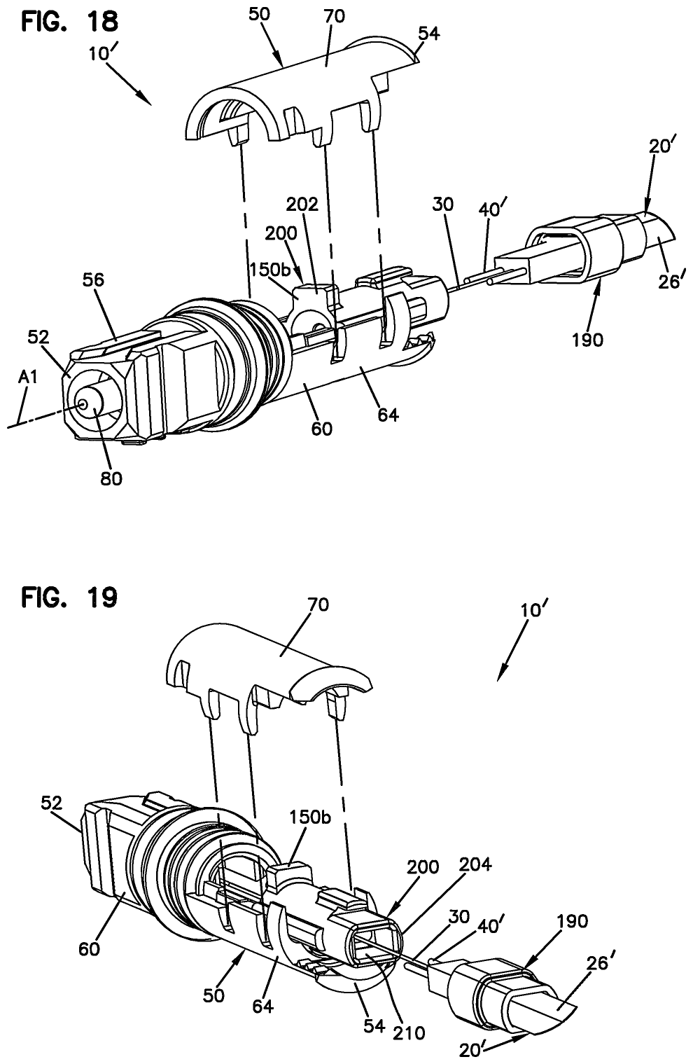

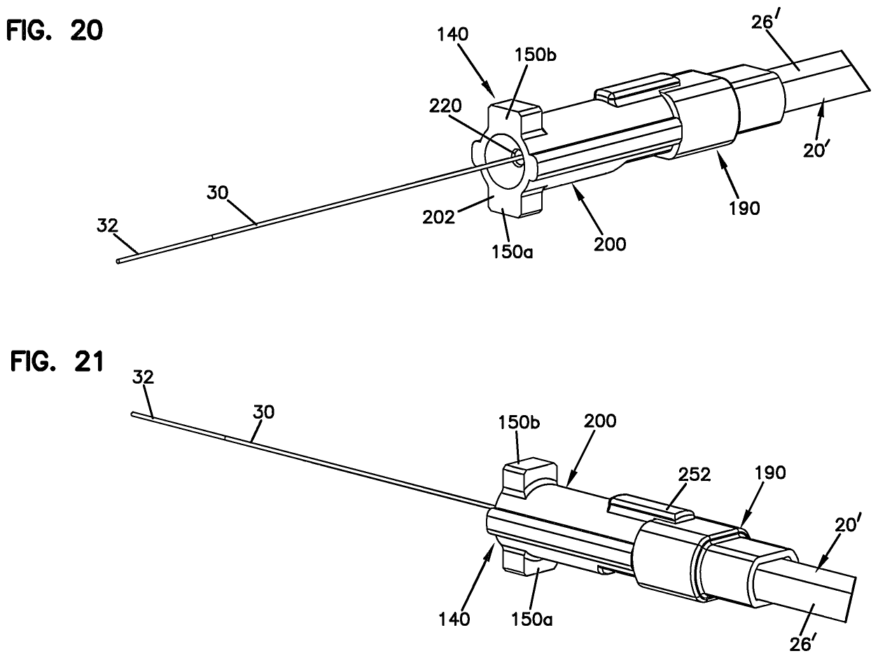

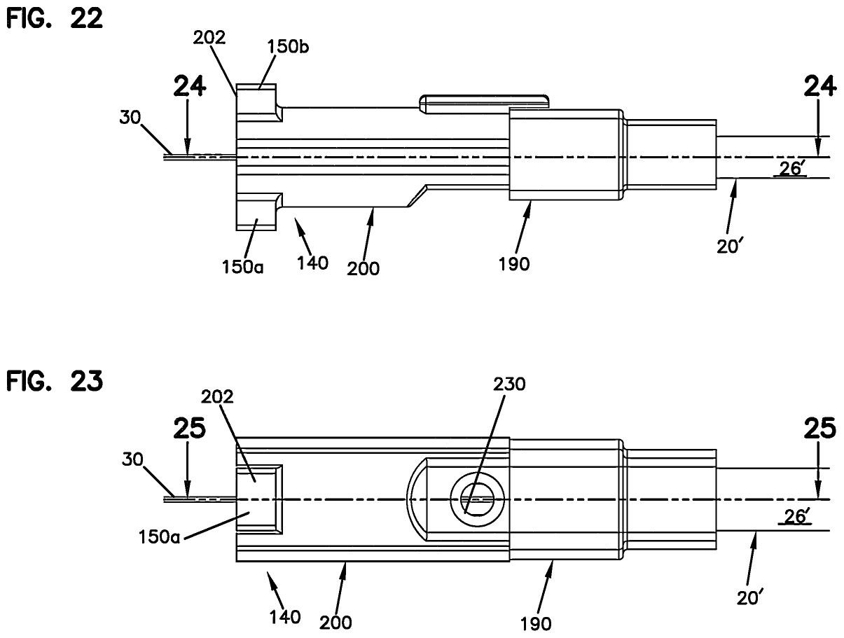

Turning now to FIGS. 18 and 19, another fiber optic connector and cable assembly 10′ is illustrated according to the principles of the present disclosure. The fiber optic connector and cable assembly 10′ is similar to the fiber optic connector and cable assembly 10. Therefore, similar features of the fiber optic connector and cable assembly 10′ will not typically be redundantly re-described.

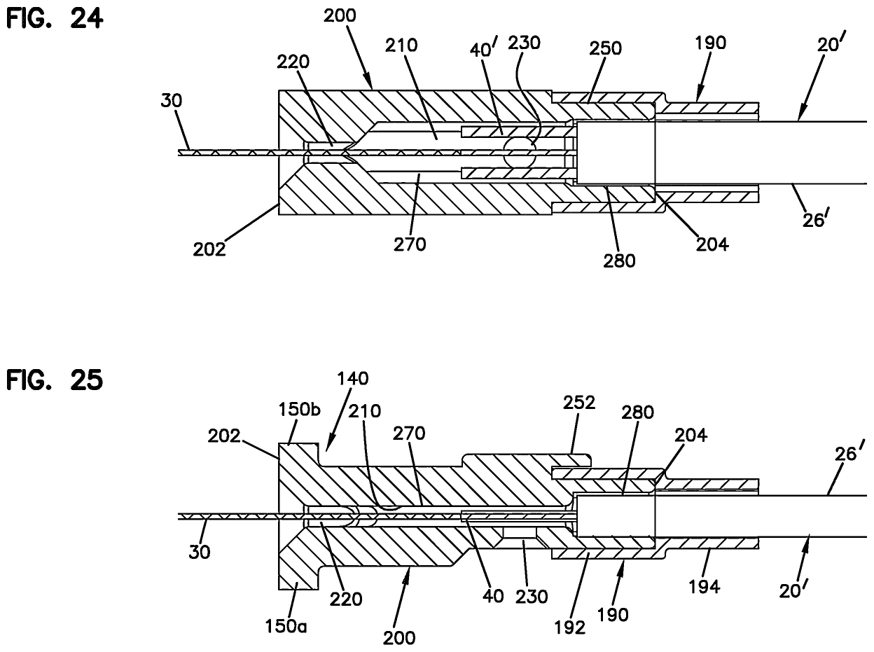

As depicted, the fiber optic connector and cable assembly 10′ is adapted to terminate a noncircular fiber optic cable 20′. In particular, the fiber optic cable 20′ includes a pair of strength members 40′ positioned opposite an optical fiber 30. A jacket 26′ of the fiber optic cable 20′ may therefore be rectangular or obround in shape. As depicted, the pair of strength members 40′ are opposite each other about a horizontal direction. The injection port 230 extends perpendicular to the horizontal plane and thereby allows the bonding material 90 to flow between the strength members 40′ (see FIG. 24).

The anchor 200 extends between a first end 202 and a second end 204. The anchor 200 includes a passage 210 that extends through the anchor 200 and through the first end 202 and the second end 204. The passage 210 includes a necked-down portion 220, a main portion 270, and a cable jacket portion 280. The passage 210 may be shaped generally rectangularly or may be shaped obround to accommodate the pair of the strength members 40′ and the jacket 26′.

The anchor 200 may further include a shrink wrap receiving area 250. As depicted, the shrink wrap receiving area 250 is on an exterior of the anchor 200 and positioned adjacent the second end 204 of the anchor 200. The cable anchor 200 may further include a finger 252 (see FIGS. 21 and 25). The finger 252 may be adapted to extend over a portion of a shrink tube 190. The shrink tube 190 may be positioned over the shrink wrap receiving area 250 and heat may be applied to the shrink tube 190 to shrink the shrink tube around a perimeter of the jacket 26′ of the fiber optic cable 20′. The shrink tube 190 may include a first portion 192 that is adapted to shrink down over the shrink wrap receiving area 250. The shrink tube 190 may include a second portion 194 adapted to shrink down over a portion of the jacket 26′ of the fiber optic cable 20′.

In certain embodiments, the fiber optic connector and cable assembly 10, 10′ provides strain relief for cables (e.g., 20, 20′) with strength members (e.g., 40, 40′) of glass and/or metal as well as for yarn of glass and/or aramid material.

The above system may include molded and/or machined parts (e.g., 60, 70, 100, and/or 200). A stripped cable (e.g., 20, 20′) may be inserted from one end. The optical fiber (e.g., 30) passes through the anchor 100, 200. Via the port 130, 230 (e.g., a hole), the anchor 100, 200 is filled with epoxy or hot melt. In this way the mechanical carrier (i.e., the strength members 40, 40′) are fixated to the anchor 100, 200 (i.e., a cable fixation part). The epoxy and/or hot melt seals the cable (e.g., 20, 20′) to the anchor 100, 200. When the ferrule 80 is added, the assembly can be inserted in the housing 50 in such a way that a tuned fiber optic connector can be achieved.

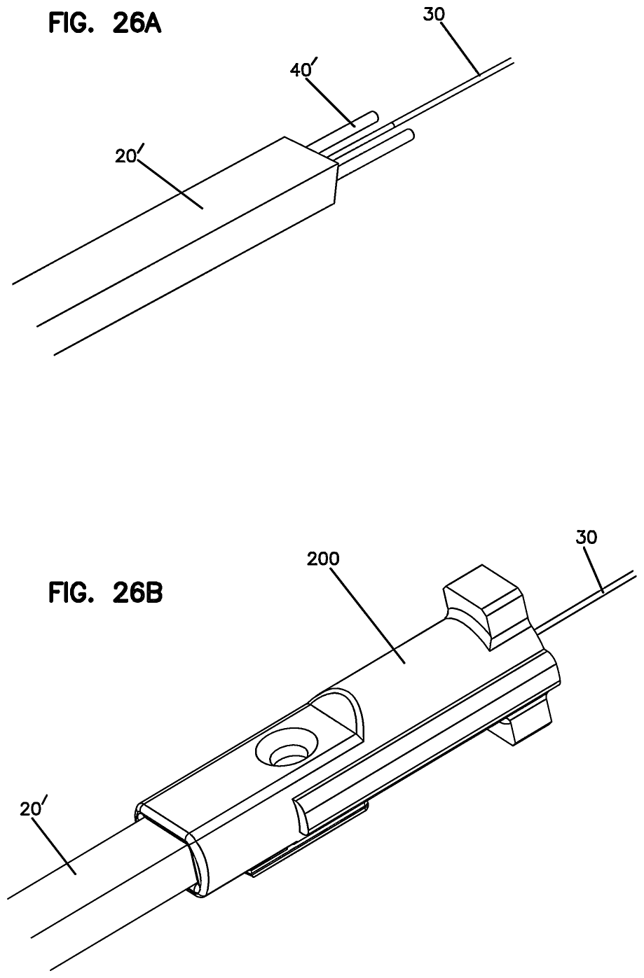

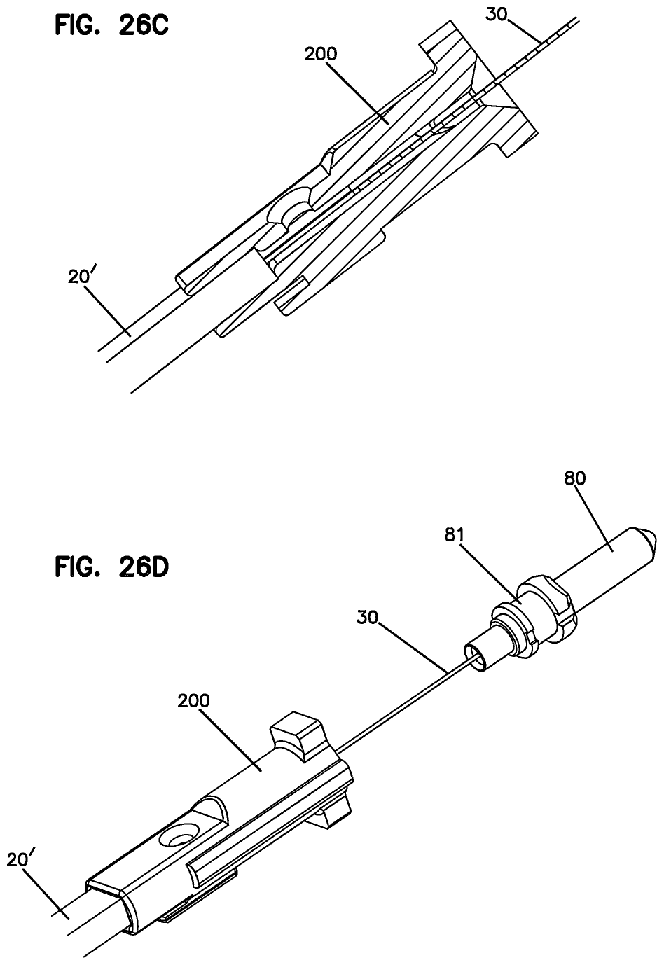

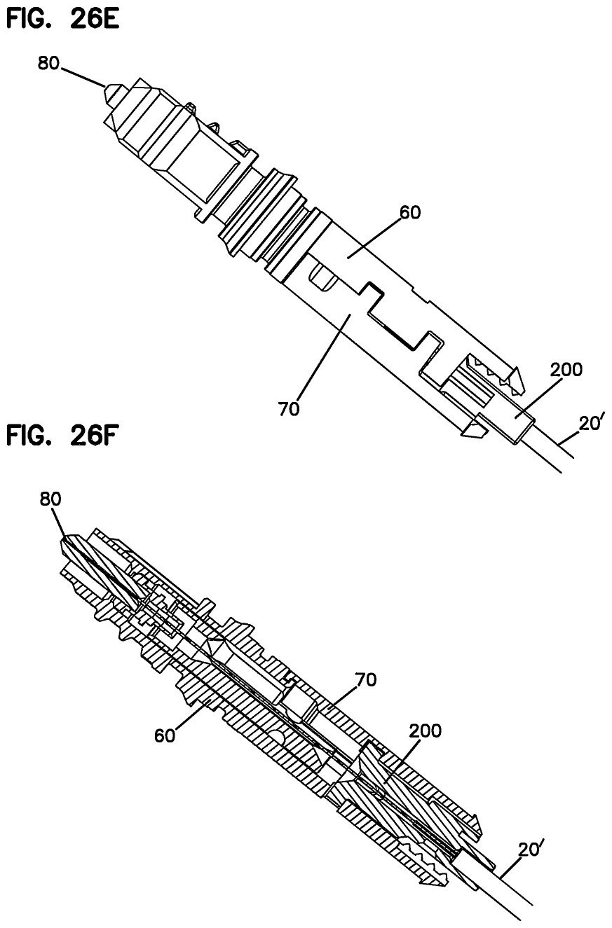

FIGS. 26A-26F illustrate an example of steps of cable termination. In particular, 1) the cable 20, 20′ is stripped (see FIG. 26A); 2) the strength members 40, 40′ and the optical fiber 30 are inserted into the anchor 100, 200 (see FIGS. 26B and 26C); 3) bonding material 90 (e.g., epoxy and/or hot melt) is injected into the port 130, 230; 4) a ferrule 80 is added to the sub-assembly (see FIG. 26D); 5) the sub-assembly is mounted in the housing 50 (see FIGS. 26E and 26F); and 6) tuning can be done by rotation of the ferrule 80 (e.g., along the axis A1). Friction between the ferrule 80 and/or a ferrule hub 81 and the connector housing 50 may prevent the optical fiber 30 from rotating at the ferrule 80. A multi-position seat between the ferrule 80 and/or a ferrule hub 81 and the connector housing 50 may prevent the optical fiber 30 from rotating at the ferrule 80. The spring 86 may maintain the friction and/or the seat between the ferrule 80 and/or the ferrule hub 81 and the connector housing 50 and thereby maintain the tuning. In certain embodiments, the fiber optic connector and cable assembly 10, 10′ may be re-tuned by again rotating the ferrule 80.

In embodiments with the optical fiber 30 fixed to the anchor 100, 200, the anchor 100, 200 may prevent the optical fiber 30 from rotating at the anchor 100, 200.

From the foregoing detailed description, it will be evident that modifications and variations can be made in the devices of the present disclosure without departing from the spirit or scope of the invention.

### PARTS LIST

A1 axis
10 fiber optic connector and cable assembly
10′ fiber optic connector and cable assembly
20 fiber optic cable
20′ fiber optic cable
22 end portion
26 jacket
26′ a jacket
28 tube
30 optical fiber
32 end portion
40 strength member
40 strength member
50 connector housing
52 first end
54 second end
56 plug portion
58 passage
60 first housing component
62 receiver
64 proximal extension
66 grooves
68 notches
70 second housing component
72 receiver
78 tabs
80 ferrule
81 hub
82 spring holder
84 tube
86 spring
88 direction
90 bonding material
100 anchor
102 first end
104 second end
110 passage
120 necked-down portion
122 outer taper
124 inner taper
130 injection port
140 attachment portion
150 retention tab
150a retention tab
150b retention tab
160 protrusions
170 main portion
180 cable jacket portion
182 notch
184 annular portion
186 bottom
190 shrink tube
192 first end
194 second end
200 anchor
202 first end
204 second end
210 passage
220 necked-down portion
230 injection port
250 shrink wrap receiving area
252 finger
270 main portion
280 cable jacket portion

1. (canceled)

2. A connectorized cable comprising:
a fiber optic cable comprising an optical fiber and a strength member; and
a fiber optic connector comprising a ferrule and a connector housing, the connector housing having a front end and a rear end, the strength member of the cable being anchored relative to the connector housing adjacent the rear end of the connector housing, the ferrule being accessible adjacent the front end of the connector housing, the optical fiber extending axially through the connector housing with a front portion of the fiber being secured with the ferrule; and
the optical fiber being fixed relative to the connector housing at a bonding chamber located rearward of the ferrule, the bonding chamber containing bonding material, the bonding chamber having a forward end defined by a passage-restriction at which a cross-dimension of the bonding chamber is reduced, wherein the passage-restriction is configured to resist the bonding material from flowing forwardly beyond the forward end of the bonding chamber during introduction of the bonding material into the bonding chamber, the optical fiber extending through the bonding chamber and the passage-restriction, the strength member being fixed relative to the connector housing at the bonding chamber.

3. The connectorized cable of claim 2, wherein the passage-restriction has a tapered lead-in or a tapered exit.

4. The connectorized cable of claim 2, further comprising a radial opening for introducing the bonding material radially into the bonding chamber from a location outside the connector housing.

5. The connectorized cable of claim 2, further comprising an anchor secured at least partially with the connector housing adjacent the rear end of the connector housing, the anchor defining the bonding chamber and the passage-restriction.

6. The connectorized cable of claim 5, wherein the fiber optic cable includes a cable jacket surrounding the optical fiber and the strength member, and wherein the anchor defines a rear pocket for receiving a front end of the cable jacket.

7. The connectorized cable of claim 2, wherein optical fiber is not fixed relative to the connector housing at a region axially between the bonding chamber and a rear end of the ferrule.

8. The connectorized cable of claim 2, wherein the strength member includes a first strength member and a second strength member aligned along a plane, wherein the optical fiber is positioned between the first and second strength members within the bonding chamber.

9. The connectorized cable of claim 2, wherein the strength member includes a yarn.

10. The connectorized cable of claim 9, wherein the yarn includes aramid yarn.

11. The connectorized cable of claim 2, wherein the bonding material adheres to the optical fiber.

12. The connectorized cable of claim 2, wherein the fiber optic cable includes a jacket surrounding the optical fiber and the strength member, and wherein the connectorized cable includes a heat shrink tube shrunk around a perimeter of the cable jacket at a location rearward of the connector housing.
